(19) United States
(12) Patent Application Publication
(10) Pub. No.: US 2006/0059436 A1
(43) Pub. Date: Mar. 16, 2006

(54) Handling and scrolling of content on screen

(75) Inventor: Mikko Nurmi, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/203,581

(22) Filed: Aug. 5, 2005

Related U.S. Application Data
(63) Continuation of application No. PCT/FI04/00533, filed on Sep. 15, 2004.

(51) Int. Cl. G06F 3/00

(52) U.S. Cl. 715/786; 715/784

(57) ABSTRACT

The invention relates to a software application adapted for scrolling content on a screen in an application window. The software application includes at least two logically distinct scroll bars in one application window, each of the scroll bars providing scrolling functionality relative to the same orientation of the content and each of the logically distinct scroll bars controlling different part of the content.

### CROSS REFERENCE TO RELATED APPLICATION

This application is a continuation of International Patent Application No. PCT/FI2004/000533 filed Sep. 15, 2004.

### FIELD OF THE INVENTION

The invention relates to handling and scrolling of content on screen especially on small-scale devices.

### BACKGROUND OF THE INVENTION

Nowadays, it is possible to transfer documents or files that are created with advanced PC programs into mobile terminals. On a PC screen handling of a large document and scrolling data contained in the document is relatively easy, since reasonable amount of data can be displayed on the screen at the same time. On the other hand, in mobile terminals the size of the screen is usually restricted due to small size of the whole device. Thereby handling of large documents and scrolling their content may be difficult on a screen of a mobile terminal.

Hereinafter, the term document is used for referring to any kind of file containing data that may be viewed on screen and scrolled up and down on screen. Such document may be a text document, a www page or some other file.

The most common means for scrolling contents of a document in current applications is a vertical scroll bar placed on either side of the screen or application window. Scrolling may be implemented also by means of push buttons; one pointing upward and one pointing downward. Pushing such button may move document for example one line or one page (or certain number of lines or pages) up or down. Also a combination of a scroll bar and push buttons is possible.

Scrolling may be accomplished also by means of certain keys, such as cursor moving keys or arrow keys, in keypad.

Content may be scrolled also in horizontal orientation, if the content of a document does not fit into the screen or window in its full width. However, scrolling in horizontal direction is usually not a problem, since usually the length of document in horizontal direction is not large. Therefore only vertical scrolling is discussed herein, even though the same principles apply to horizontal scrolling.

FIGS. 1A and 1B show an example of a conventional scroll bar 100, which comprises an upward pointing arrow 101, downward pointing arrow 102, and an elevator 103. Single clicking the upward pointing arrow 101 moves document one line (or certain number of lines) up, single clicking the downward pointing arrow 102 moves document one line (or certain number of lines) down. Single clicking the empty space within the scroll bar, above or below the elevator, moves the document one screen (or certain number of screens) up or down.

Sliding the elevator 103, 103′ up or down in the scroll bar moves the view anywhere in the document. The size of the elevator 103, 103′ is relative to the length of the document. When the elevator in the scroll bar is very small, there is a lot of content on the document. This kind of situation is shown in FIG. 1B (elevator 103′). If the elevator is big, there is only a small amount of content on the document. This kind of situation is shown in FIG. 1A (elevator 103). Thus, if the document is long, a relatively small movement of the elevator scrolls up or down a relatively large amount of data.

It is possible that many windows comprising a scroll bar are embedded within each other. For example, sometimes www pages contain an input box into which the user may type. That is, there is an embedded data window in the www browser application window. This kind of input boxes may be so long that they have a scroll bar of their own. If the page that contains the input box is also so long that it requires a scroll bar, there are eventually two scroll bars in one view. FIG. 2 shows this kind of a situation, wherein a browser window 200 comprises a scroll bar 201 for scrolling the content of the browser window. The content of the browser window comprises text 203 and an input box 204.

In a mobile terminal or some other device having a relatively small screen, the use of scroll bars described above may be difficult, since the screen, and thereby also the scroll bar, is usually small in relation to the length of the document and so even a small movement of the elevator scrolls up or down a relatively large amount of data. This may cause that the document is accidentally scrolled more than the user actually wanted and/or that finding the right point in a large document is slow and burdensome.

Accordingly, there is a need to improve document handling and scrolling especially in devices having a relatively small screen.

### SUMMARY OF THE INVENTION

An object of the invention is to provide a new solution for scrolling content on screen.

An idea of the invention is to have, as part of a software application, multiple scroll bars arranged so that each scroll bar relates to a different part of the content that is handled. For example, one scroll bar may cover the whole document while another covers only a part of the document (for example one specific paragraph, chapter, page or section, or currently active/visible paragraph, chapter, page or section), or one scroll bar may cover the beginning of the content while another covers the end of the content. One more alternative is that one scroll bar covers currently visible document and another scroll bar provides a possibility to scroll a list of other available documents.

That is, in comparison to prior art wherein it is possible to have additional scroll bars embedded in the content shown in an application window, now the software application itself provides two or more scroll bars for handling the content shown in the application window (irrespective of whether the content comprises embedded scroll bars).

Thus, according to a first aspect of the invention, there is provided a device for handling content comprising
a memory,
a processing unit controlling operation of said device according to software stored in said memory,
a screen for viewing content,
said memory comprising a software application adapted for scrolling content on the screen in an application window, wherein the software application comprises:
at least two logically distinct scroll bars in one application window, each of the scroll bars providing scrolling functionality relative to the same orientation of the content and each of the logically distinct scroll bars controlling different part of the content.

According to a second aspect of the invention, there is provided a software application adapted for scrolling content on a screen in an application window, wherein the software application comprises:
at least two logically distinct scroll bars in one application window, each of the scroll bars providing scrolling functionality relative to the same orientation of the content and each of the logically distinct scroll bars controlling different part of the content.

According to a third aspect of the invention, there is provided a method for use in a software application adapted for scrolling content on a screen in an application window, wherein the method comprises:
providing at least two logically distinct scroll bars in one application window, each of the scroll bars providing scrolling functionality relative to the same orientation of the content and each of the logically distinct scroll bars controlling different part of the content.

In one practical implementation, there are two parallel scroll bars. However, also more than two scroll bars may be used. Furthermore it is possible to embed two or more logically distinct scroll bars into one physical scroll bar.

Dependent claims contain embodiments of the invention. The subject matter contained in dependent claims relating to a particular aspect of the invention is also applicable to other aspects of the invention.

By means of the scrolling provided by the scroll bars according to embodiments of the invention, it is easier to scroll long documents and to find specific points therein with greater precision. Thereby user experience can be improved. The solution is especially suitable for devices, in which the size of a screen is restricted, but it may be used also in other devices.

### BRIEF DESCRIPTION OF THE DRAWINGS

Embodiments of the invention will now be described by way of example with reference to the accompanying drawings in which:

FIG. 1A shows an example of a conventional scroll bar;

FIG. 1B shows another example of a conventional scroll bar;

FIG. 2 illustrates a document view in a conventional application window;

FIG. 3 illustrates a document view in an application window according to an embodiment of the invention;

FIG. 4 illustrates a document view in an application window according to another embodiment of the invention;

FIG. 5 illustrates a document view in an application window according to still another embodiment of the invention;

FIG. 6 illustrates a document view in an application window showing an example of embedding two logically distinct scroll bars into one physical scroll bar; and

FIG. 7 illustrates a device according to an embodiment of the invention.

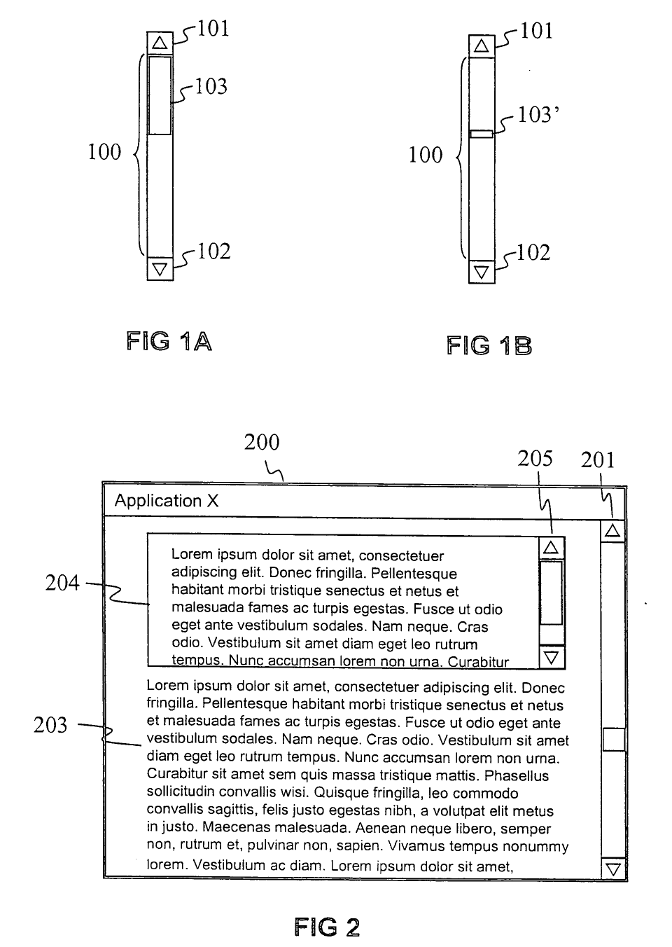

### DETAILED DESCRIPTION

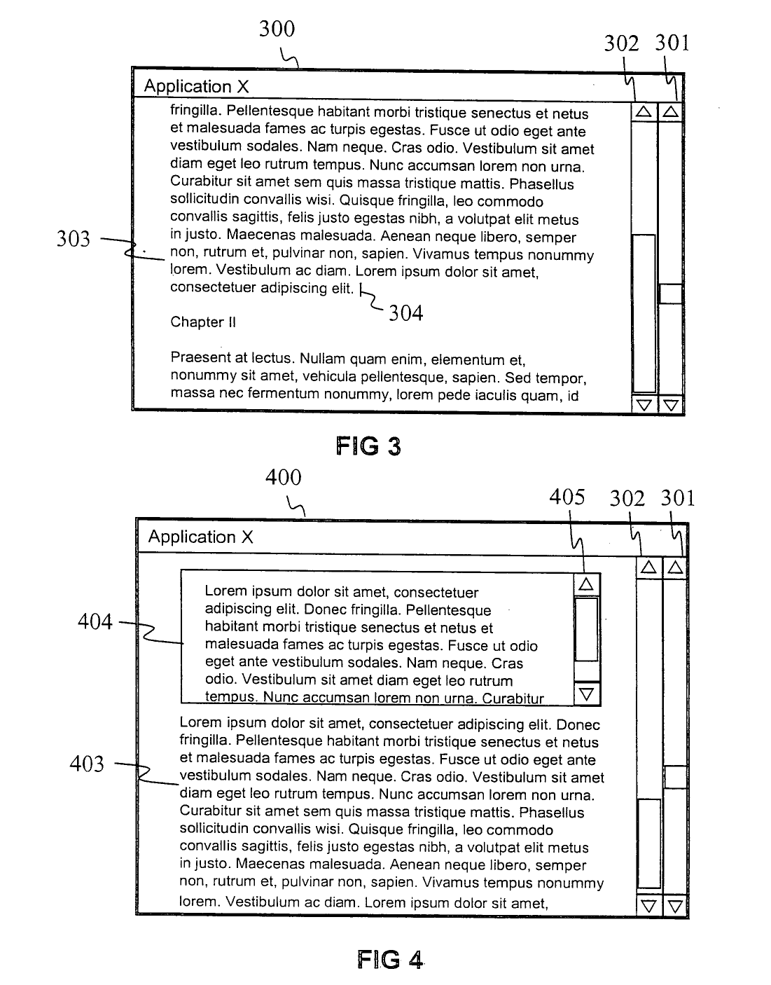

FIG. 3 illustrates a document view in an application window 300 according to an embodiment of the invention. The application window comprises two parallel scroll bars 301 and 302 on the right hand side of the window. Both scroll bars control scrolling of the content 303. Here the scroll bar 301 controls the whole document and the scroll bar 302 controls one chapter of the document. From the size and position of the elevator of the scroll bar 301 it can be seen that there is more content below and above the currently visible part. Correspondingly, from the size and position of the elevator of the scroll bar 302 it can be seen that the cursor 304 is currently in the end of the chapter that the scroll bar 302 controls.

In one alternative of the invention, the scroll bar 302 may control currently active chapter of the document (or some other suitable part of the document). That is, when cursor 304 is moved one line down to chapter II, the scroll bar 302 begins to control the content of chapter II. It is also possible that scroll bar 302 is adapted to control the currently visible part of the document. As an alternative to the chapter, the part of the document that the scroll bar 302 controls may be for example a paragraph, page or section. Yet another alternative is to provide the user with a possibility to define which part of the document the “additional” scroll bar 302 controls. For example, if the user is editing certain part of the document, he or she can set that the scroll bar 302 controls that certain part, while the scroll bar 301 operates normally on the whole document.

It is clear to a person skilled in the art that the invention may be implemented so that the scroll bars 301 and 302 become visible to the user only when the content that is viewed does not fit into the screen in its full length. (If the whole content fits into one screen, there is naturally no need to scroll the content up or down.)

The difference between the logically distinct scroll bars of the invention for example in FIG. 3 and the scroll bars shown in FIG. 2 is that in FIG. 2 the scroll bar 205 is part of the content that is scrolled with the scroll bar 201 of the application window. That is, scroll bar 205 is not provided as part of the software application showing the content but as part of the content to be shown. Thereby scroll bar 205 is visible only if the portion of the content comprising the input box 204 is visible. On the other hand, in FIG. 3 both scroll bars are integral parts of the software application. Moreover, in some implementations the part of the document that the scroll bar 302 controls may vary dynamically.

FIG. 4 illustrates a document view in an application window 400 according to another embodiment of the invention. This example illustrates further the difference between the invention and the situation shown in FIG. 2.

Similarly to FIG. 3, the application window 400 comprises two parallel scroll bars 301 and 302 on the right hand side of the window. Now the content that is scrolled by means of the two scroll bars 301 and 302 comprises text 403 and an input box 404. The input box 404 comprises a scroll bar of its own, but this scroll bar is visible in the application window only when the input box 404 is visible. Moreover, the scroll bar of the input box 404 is not part of the application wherein the content is viewed.

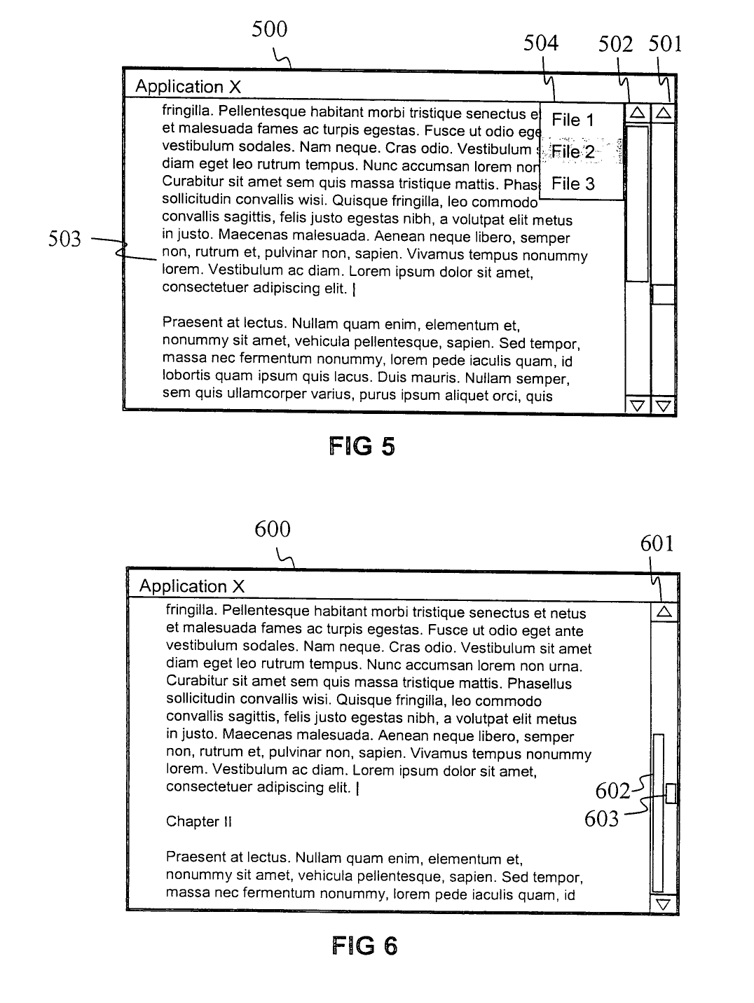

FIG. 5 illustrates a document view in an application window 500 according to still another embodiment of the invention. Similarly to FIGS. 3 and 4, the application window 500 comprises two parallel scroll bars 501 and 502 on the right hand side of the window.

Here the scroll bar 501 controls the document that is currently visible and the scroll bar 502 can be used for scrolling a list of other available documents. That is, herein the content that is scrolled is considered to comprise a plurality of documents. The documents that are listed may be for example currently open application windows, a selection of links to www pages, sub-pages of a particular www page, documents contained in a particular folder, or some other set of documents.

Each of the FIGS. 3-5 shows two distinct scroll bars. Naturally there may be more than two scroll bars. Alternatively, functionality of two (or more) logically different scroll bars may be embedded into one physical scroll bar. In that case, the user sees only one scroll bar, but the operating mode of the this scroll bar may be altered so that in one mode the scroll bar provides functionality one logically distinct scroll bar and another mode providing functionality of another logically distinct scroll bar. A specific action of the user changes the operating mode of the scroll bar. For example, the operating mode of the scroll bar may be changed by pushing a certain button shown in the application window, by holding down certain button on a keypad, by clicking with mouse, or by clicking and holding with mouse.

FIG. 6 illustrates a document view in an application window 600 showing another example of embedding two logically distinct scroll bars into one physical scroll bar. Now an application window 600 comprises only one scroll bar 601 on the right hand side of the window. The scroll bar 601 comprises two distinct elevators 602 and 603 corresponding to two logically distinct scroll bars. Each of the elevators provides different type of scrolling functionality.

In order to facilitate identification of logically distinct scroll bars it is possible to use for example different colours for different elevators (or for different scroll bars in the previous examples). Alternatively the identification of logically distinct scroll bars may be based on that a scroll bar having a larger elevator controls a smaller portion of the content and a scroll bar having a smaller elevator controls a larger portion of the content.

Embedding functionality of more than one logically distinct scroll bar into one physical scroll bar saves space in the application window.

In addition, the system may be adapted to provide the user a possibility to activate one of the logically distinct scroll bars, whereupon certain keys, such as cursor moving keys or arrow keys, of keypad can be used for accomplishing scrolling in accordance with the currently active logically distinct scroll bar. The currently active scroll bar may be for example highlighted with certain colour so that the user may easily identify which scroll bar is currently active.

It is clear to a man skilled in the art that visual appearance of the scroll bars according to the invention may differ from those presented in FIGS. 3-6. Also the positioning of the scroll bars and the operation of an individual scroll bar may vary in different implementations of the invention. Furthermore, a combination of different scroll bar arrangements can be implemented.

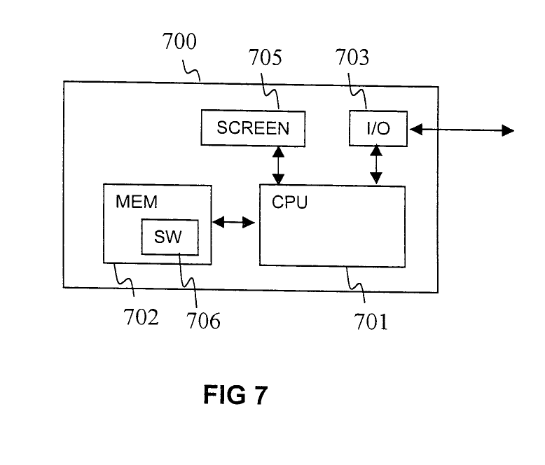

FIG. 7 illustrates a device 700 according to an embodiment of the invention. Such device may be for example a mobile terminal, a handheld computer, a smart phone, a laptop computer, a desktop computer or some other suitable device.

The device 700 comprises a processing unit 701 and an input/output module 703 coupled to the processing unit 701. The processing unit 701 is coupled to a memory 702 and screen 705 as well. The memory comprises software application 706 executable in the processing unit 701.

The processing unit controls, in accordance with the software application 706, the device to show an application window on the screen 705 for showing content to the user of the device 700. In accordance with the software application 706, the application window comprises at least two logically distinct scroll bars, each of the scroll bars providing scrolling functionality relative to the same orientation of the content and each of the logically distinct scroll bars controlling different part of the content.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A device for handling content comprising
a memory,
a processing unit controlling operation of said device according to software stored in said memory,
a screen for viewing content,
said memory comprising a software application adapted for scrolling content on the screen in an application window, wherein the software application comprises:
at least two logically distinct scroll bars in one application window, each of the scroll bars providing scrolling functionality relative to the same orientation of the content and each of the logically distinct scroll bars controlling different part of the content.

2. A device according to claim 1, wherein said logically distinct scroll bars are physically distinct scroll bars.

3. A device according to claim 1, wherein at least two of said logically distinct scroll bars are comprised in one physical scroll bar, a specific action being used for controlling operating mode of the physical scroll bar, one operating mode providing functionality of one logically distinct scroll bar and another mode providing functionality of another logically distinct scroll bar.

4. A device according to claim 3, wherein said specific action is one of the following: pushing a button, holding down a key on a key-pad, clicking with mouse, clicking and holding with mouse.

5. A device according to claim 1, wherein said logically distinct scroll bars are comprised in one physical scroll bar, which comprises distinct elevators for each logically distinct scroll bar.

6. A device according to claim 1, wherein said logically distinct scroll bars are adapted to be used for scrolling content of a document, one logically distinct scroll bar controlling a certain part of the document and another logically distinct scroll bar controlling the document as a whole.

7. A device according to claim 6, wherein said certain part of the document varies dynamically depending on which part of the document is currently viewed and/or active.

8. A device according to claim 6, wherein said certain part of the document is currently active and/or currently visible part of the document.

9. A device according to claim 6, wherein said certain part of the document is one or more paragraphs, chapters, pages, or sections of the document.

10. A device according to claim 1, wherein said logically distinct scroll bars are adapted to be used for scrolling content of a document, one logically distinct scroll bar controlling the beginning of the document and another logically distinct scroll bar controlling the end of the document.

11. A device according to claim 1, wherein said logically distinct scroll bars are adapted to be used for scrolling content of a plurality of documents, one logically distinct scroll bar controlling the document that is currently open and another logically distinct scroll bar controlling a list of other available documents.

12. A device according to claim 11, wherein said documents are www pages.

13. A device according to claim 11, wherein said documents are documents stored on a specific location.

14. A device according to claim 1, wherein said device is a mobile terminal, a handheld computer, a smart phone, a laptop computer or a desktop computer.

15. A software application adapted for scrolling content on a screen in an application window, wherein the software application comprises:
at least two logically distinct scroll bars in one application window, each of the scroll bars providing scrolling functionality relative to the same orientation of the content and each of the logically distinct scroll bars controlling different part of the content.

16. A software application according to claim 15, wherein said logically distinct scroll bars are physically distinct scroll bars.

17. A software application according to claim 15, wherein at least two of said logically distinct scroll bars are comprised in one physical scroll bar, a specific action being used for controlling operating mode of the physical scroll bar, one operating mode providing functionality of one logically distinct scroll bar and another mode providing functionality of another logically distinct scroll bar.

18. A software application according to claim 17, wherein said specific action is one of the following: pushing a button, holding down a key on a keypad, clicking with mouse, clicking and holding with mouse.

19. A software application according to claim 15, wherein said logically distinct scroll bars are comprised in one physical scroll bar, which comprises distinct elevators for each logically distinct scroll bar.

20. A software application according to claim 15, wherein said logically distinct scroll bars are adapted to be used for scrolling content of a document, one logically distinct scroll bar controlling a certain part of the document and another logically distinct scroll bar controlling the document as a whole.

21. A software application according to claim 20, wherein said certain part of the document varies dynamically depending on which part of the document is currently viewed and/or active.

22. A software application according to claim 20, wherein said certain part of the document is currently active and/or currently visible part of the document.

23. A software application according to claim 20, wherein said certain part of the document is one or more paragraphs, chapters, pages, or sections of the document.

24. A software application according to claim 15, wherein said logically distinct scroll bars are adapted to be used for scrolling content of a document, one logically distinct scroll bar controlling the beginning of the document and another logically distinct scroll bar controlling the end of the document.

25. A software application according to claim 15, wherein said logically distinct scroll bars are adapted to be used for scrolling content of a plurality of documents, one logically distinct scroll bar controlling the document that is currently open and another logically distinct scroll bar controlling a list of other available documents.

26. A software application according to claim 25, wherein said documents are www pages.

27. A software application according to claim 25, wherein said documents are documents stored on a specific location.

28. A software application according to claim 15 stored on a carrier.

29. A method for use in a software application adapted for scrolling content on a screen in an application window, wherein the method comprises:
providing at least two logically distinct scroll bars in one application window, each of the scroll bars providing scrolling functionality relative to the same orientation of the content and each of the logically distinct scroll bars controlling different part of the content.
